(19) United States
(12) Patent Application Publication
(10) Pub. No.: US 2011/0226927 A1
(43) Pub. Date: Sep. 22, 2011

(54) FIXATION STRUCTURE OF ANTENNA APPARATUS

(75) Inventors: Kyuichi SATO, Oga-shi (JP); Satoshi Sato, Akita-shi (JP)

(73) Assignee: MITSUMI ELECTRIC CO., LTD., Tama-shi (JP)

(21) Appl. No.: 13/050,640

(22) Filed: Mar. 17, 2011

(30) Foreign Application Priority Data
Mar. 18, 2010 (JP) 2010-061731
Mar. 18, 2010 (JP) 2010-061739
Mar. 4, 2011 (JP) 2011-047211

(51) Int. Cl. H01Q 1/12

(52) U.S. Cl. 248/534

(57) ABSTRACT

Disclosed is a fixation structure of an antenna apparatus including a base member in which a nut portion is formed, a fixation member which is inserted in the fixation opening and has a shape that can contact with a periphery of the fixation opening when the antenna apparatus is attached to the mounting surface and a bolt which is screwed into the nut portion in a state where the bolt is inserted into the fixation member, and the bolt is screwed into the nut portion to hold and fix the mounting surface by the base member and the fixation member after the fixation member and the bolt are inserted into the fixation opening and the fixation member is rotated for a predetermined angle, the bolt being a shaft center, the fixation member comprises a rotation inhibiting unit which is formed facing the base member, and the base member comprises an engaging hole by which the rotation inhibiting unit is engaged when the bolt is screwed into the nut portion.

### BACKGROUND OF THE INVENTION

1. Field of the Invention

The present invention relates to a fixation structure of an antenna apparatus, and particularly to a technique preferable for fixing the antenna apparatus to a mounting surface via a fixation opening having a large aperture.

2. Description of Related Art

Conventionally, an antenna apparatus which can receive radio waves of a plurality of frequency bands such as radio waves for GPS (Global Positioning System), cellular phone and remote control engine starter is known as an antenna apparatus to be mounted on the roof of a vehicle or the like. Such antenna apparatus is fixed by a suitable method by inserting a fixation unit which is provided at the bottom surface of the antenna apparatus into a fixation hole (fixation opening) which is formed in the mounting surface such as the roof of a vehicle or the like (for example, JP2006-77928).

FIG. 25A is a diagram showing an example of the fixation structure of the conventional antenna apparatus before the antenna apparatus is inserted into the fixation opening. FIG. 25B is a diagram showing an example of the fixation structure of the convention antenna apparatus after the antenna apparatus is inserted into the fixation opening.

As shown in FIGS. 25A and 25B, the antenna apparatus 100 includes a fixation unit 101 which is provided at the bottom surface of the antenna apparatus 100 so as to protrude, a fixation bracket (clip) 102 which is arranged outside of the fixation unit 101 and a bolt 103 which is paired with a nut portion formed at the fixation unit 101. Further, in the mounting surface 200 which is the roof of a vehicle or the like, a fixation opening 200a in a circle shape or a rectangular shape having a small aperture, for example, is formed.

As shown in FIG. 25A, first, the fixation unit 101 is inserted into the fixation opening 200a in a state where the fixation bracket 102 is assembled to the fixation unit 101 by the bolt 103. Because the fixation bracket 102 is formed so as to widen upward, the fixation bracket 102 is to be pressed by the inner edge of the fixation opening 200a when the fixation unit 101 is inserted into the fixation opening 200a. As shown in FIG. 25B, when the entire fixation unit 101 including the fixation bracket 102 is inserted into the fixation opening 200a, the fixation bracket 102 restores the original form by its own springing force. Thereafter, when the bolt 103 is screwed, the fixation bracket 102 deforms by being pushed out by the fixation unit 101. Thereby, the mounting surface 200 is held by the bottom surface of the antenna apparatus 100 and the fixation bracket 102, and the antenna apparatus 100 is fixed.

An antenna board on which an antenna pattern and a patch antenna are mounted is disposed inside of the antenna apparatus 100, and wirings such as a signal outputting cable and the like are connected to the antenna board in advance. The wirings are pulled out from an opening provided at the fixation unit 101 and are routed in the vehicle via the fixation opening 200a.

As described above, because the wirings are connected in advance in the conventional antenna apparatus, there is a need to fix the antenna apparatus after inserting the wirings in the fixation opening. Thus, the attachment operation of the antenna apparatus to the vehicle has been troublesome. Here, when a connector portion is provided each on the antenna apparatus side and on the wiring side, the wirings can be connected after the antenna apparatus is attached to the vehicle (so-called direct connector). Therefore, the attachment operation will be simplified for great extent. In such case, because the connector portion on the antenna apparatus side is to be exposed at the back side of the mounting surface from the fixation opening, the fixation opening becomes inevitably large.

However, when trying to fix the antenna apparatus by the above described fixation mechanism to the fixation opening of a large aperture so as to enable the direct connector, the external shape of the fixation bracket becomes large and the thickness will be thicker for maintaining its intensity. As a result, the fixation bracket cannot be elastically deformed easily and it is difficult to firmly fix the antenna apparatus. Further, the space (height) in the back of the roof of a vehicle which is the mounting surface is limited, thereby restricting the size of the fixation bracket. Therefore, it is not preferable to make the shape of the fixation bracket larger.

On the other hand, when the antenna apparatus is a separate type in which the fixation bracket and the bolt are to be attached from the back of the roof after the fixation unit is inserted into the fixation opening, the antenna apparatus can be firmly fixed without making the fixation bracket in large size because elasticity is not required in the fixation bracket. However, the antenna apparatus which is delivered in a state where the fixation bracket and the bolt are assembled to the fixation portion needs to be disassembled once at the manufacturer. Therefore, the attachment operation can be troublesome.

### SUMMARY OF THE INVENTION

In order to solve the above problems, an object of the present invention is to provide a fixation structure of an antenna apparatus by which the antenna apparatus can be firmly fixed to the mounting surface via a fixation opening having a large aperture without reducing the efficiency of the attachment operation.

In view of the above, a fixation structure of an antenna apparatus in which the antenna apparatus is fixed to a fixation opening provided in a mounting surface reflecting one aspect of the present invention includes a base member in which a nut portion is formed, a fixation member which is inserted in the fixation opening and has a shape that can contact with a periphery of the fixation opening when the antenna apparatus is attached to the mounting surface and a bolt which is screwed into the nut portion in a state where the bolt is inserted into the fixation member, and the bolt is screwed into the nut portion to hold and fix the mounting surface by the base member and the fixation member after the fixation member and the bolt are inserted into the fixation opening and the fixation member is rotated for a predetermined angle, the bolt being a shaft center, the fixation member comprises a rotation inhibiting unit which is formed facing the base member, and the base member comprises an engaging hole by which the rotation inhibiting unit is engaged when the bolt is screwed into the nut portion.

In the above fixation structure of the antenna apparatus, preferably, the base member comprises a stepped portion which is provided in the engaging hole in continuation with the engaging hole, and the rotation inhibiting unit is maintained to be in a state contacting with the stepped portion at beginning of screwing of the bolt into the nut portion and the rotation inhibiting unit is engaged with the engaging hole when the fixation member is rotated for the predetermined angle.

In the above fixation structure of the antenna apparatus, preferably, the rotation inhibiting unit includes a concave portion at a periphery surface of the rotation inhibiting unit, the stepped portion includes a convex portion which engages with the concave portion, and the rotation inhibiting unit is maintained to be in the state contacting with the stepped portion by the concave portion and the convex portion engaging with each other to be in a locked state, and the locked state is released by the concave portion or the convex portion being elastically deformed in association with a rotation of the fixation member.

In the above fixation structure of the antenna apparatus, preferably, the fixation opening has a polygonal shape, the fixation member comprises a rotation shaft portion in which an insertion hole for inserting the bolt is formed and a plurality of legs which extend radially from the rotation shaft portion and are bent in a L-shape toward the base member, and lengths from a center of the rotation shaft portion to bent parts of the plurality of legs correspond to lengths from a gravity center of the fixation opening to corner apexes of the fixation opening.

In the above fixation structure of the antenna apparatus, preferably, the fixation opening has a regular polygon shape.

### BRIEF DESCRIPTION OF THE DRAWINGS

The present invention will become more fully understood from the detailed description given hereinbelow and the appended drawings which are given by way of illustration only, and thus are not intended as a definition of the limits of the present invention, and wherein:

FIG. 1 is a diagram showing an outer appearance of an antenna apparatus of an embodiment;

FIG. 2 is a diagram showing a part of a mounting surface of the antenna apparatus;

FIG. 3 is a diagram showing an inner structure of an antenna main body;

FIG. 4 is a diagram showing a structure of a base member as a backside structure of the antenna main body of the first embodiment;

FIG. 5 is a diagram showing an example of a snap connector;

FIG. 6 is a diagram showing a method for fixing an antenna board to which the snap connectors are mounted to the base member in the antenna apparatus of the first embodiment;

FIG. 7 is a diagram showing a state where the antenna board to which the snap connectors are mounted is fixed to the base member in the antenna apparatus of the first embodiment;

FIG. 8 is a diagram showing another example of the snap connector;

FIG. 9 is a diagram showing another example of the snap connector;

FIG. 10 is an exploded diagram of a fixation mechanism of the first embodiment;

FIG. 11 is a diagram showing a state before the fixation mechanism is inserted into a fixation opening;

FIG. 12 is a diagram showing a state before the fixation mechanism is inserted into the fixation opening;

FIG. 13 is a diagram showing a state after the fixation mechanism is inserted into the fixation opening;

FIG. 14 is a diagram showing a positioning process of the antenna apparatus;

FIG. 15 is a diagram showing a state where the position of the antenna apparatus is decided;

FIG. 16 is a diagram showing a state where the fixation mechanism is completely inserted into the fixation opening;

FIG. 17 is a diagram showing a state where the antenna apparatus is fixed to the mounting surface;

FIG. 18 is a diagram showing a structure of the base member of the second embodiment;

FIG. 19 is an enlarged diagram showing a structure of the fixation mechanism of the second embodiment;

FIG. 20 is a partial cross-sectional view showing the structure of the fixation mechanism of the second embodiment;

FIG. 21 is a diagram showing a state where a fixation member is rotated;

FIG. 22 is a diagram showing a state where the antenna apparatus is fixed to the mounting surface;

FIG. 23 is a diagram showing a state where the antenna apparatus is fixed to the mounting surface;

FIG. 24 is a diagram showing a structure of the base member of the third embodiment;

FIG. 25A is a diagram showing an example of the fixation structure of the conventional antenna apparatus before the antenna apparatus is inserted into the fixation opening; and

FIG. 25B is a diagram showing an example of the fixation structure of the conventional antenna apparatus after the antenna apparatus is inserted into the fixation opening.

### DESCRIPTION OF THE PREFERRED EMBODIMENTS

Hereinafter, embodiments of the present invention will be described in detail based on the drawings.

### First Embodiment

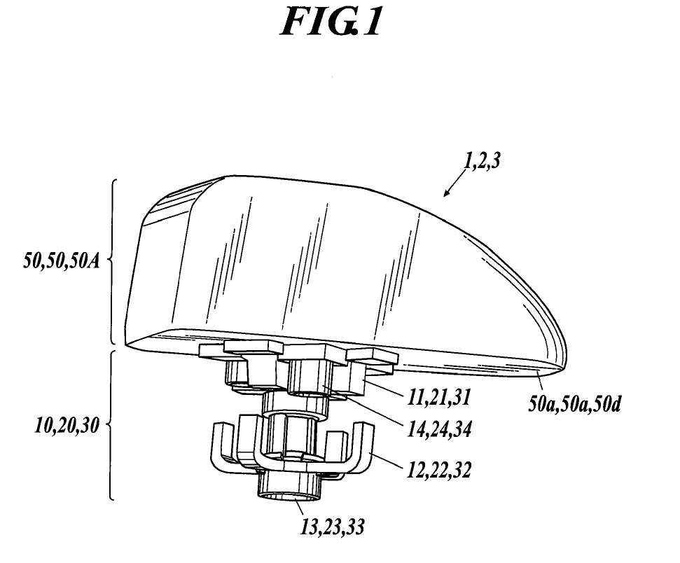

FIG. 1 is a diagram showing an outer appearance of an antenna apparatus 1 of the embodiment.

In FIG. 1, the first symbol among the symbols attached to each part corresponds to the first embodiment. The antenna apparatus 1 shown in FIG. 1 is an antenna apparatus which can receive radio waves of plurality of frequency bands such as radio waves for GPS, cellular phone, remote control engine starter and the like and is fixed to a mounting surface such as the roof of a vehicle, for example.

As shown in FIG. 1, the antenna apparatus 1 of the first embodiment includes an antenna main body 50 in which an antenna board (the after-mentioned first antenna board 34 and second antenna board 44) on which an antenna pattern and a patch antenna are mounted is housed and a fixation mechanism 10 for fixing the antenna apparatus 1 to the mounting surface. The fixation mechanism 10 includes a base member 11 which is provided so as to protrude from a protection member 50a which is provided at the bottom surface of the antenna main body 50, a fixation member 12 which holds the mounting surface with the protection member 50a and a bolt 13 which is to be screwed to the base member 11 in a state where the bolt 13 is inserted in the fixation member 12. Further, connector portions 14 for connecting wirings to the vehicle are disposed at the base member 11.

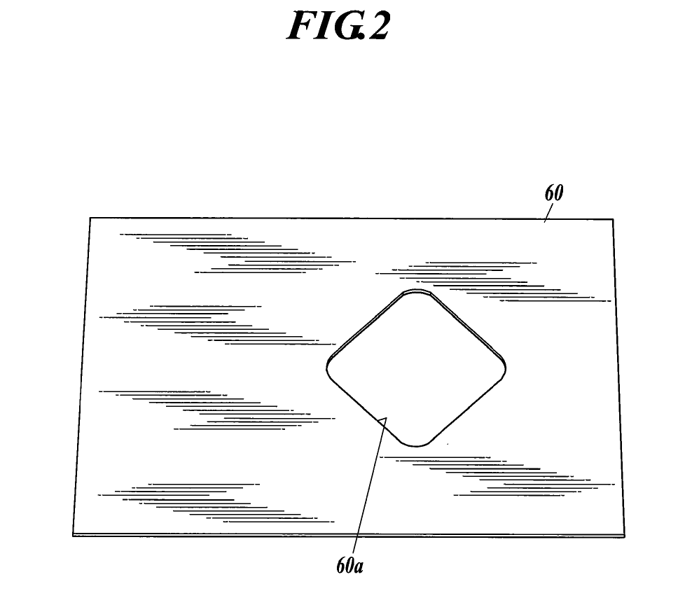

FIG. 2 is a diagram showing a part of the mounting surface (for example, roof of a vehicle) 60 of the antenna apparatus 1. As shown in FIG. 2, a fixation opening 60a formed in an approximately square shape is formed in the mounting surface 60.

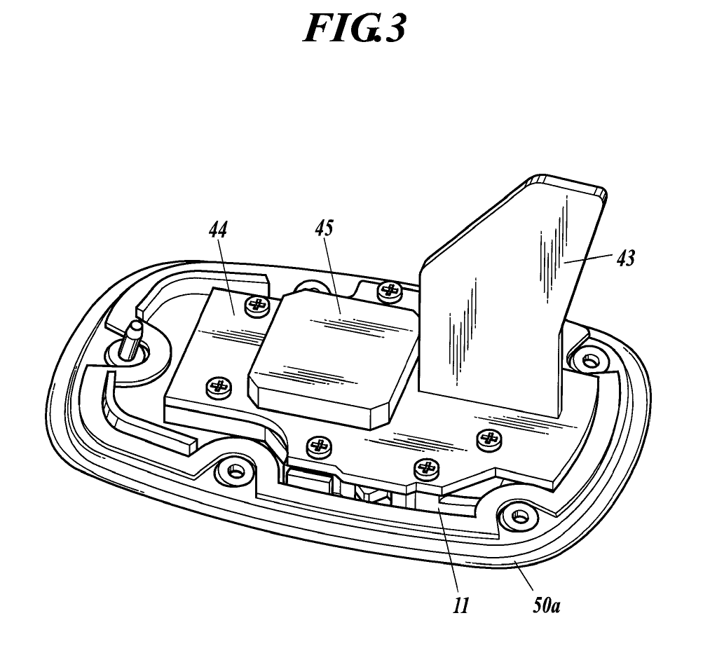

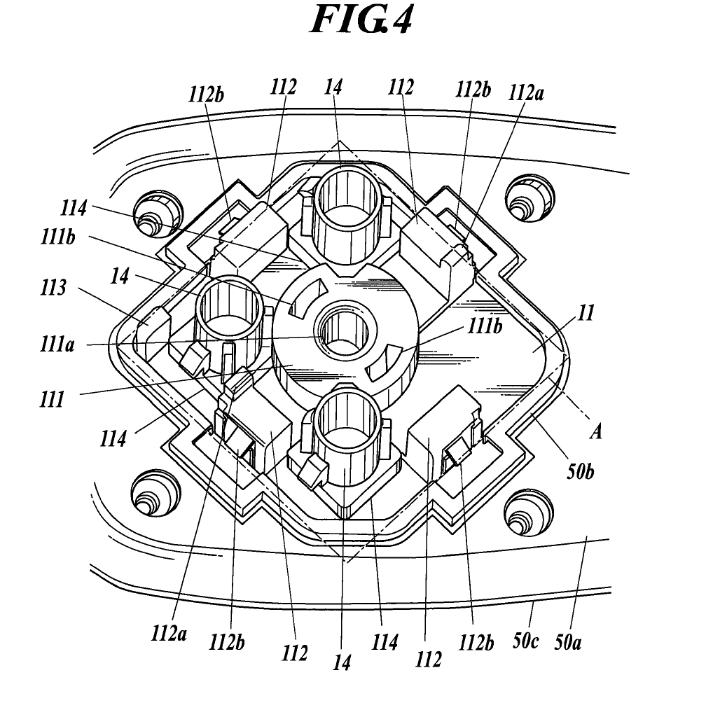

FIG. 3 is a diagram showing an inner structure of the antenna main body 50 and FIG. 4 is a diagram showing a structure of the base member 11 as the backside structure of the antenna main body 50.

As shown in FIG. 3, a first antenna board 43 in which an antenna pattern (not shown in the drawing) which can receive radio waves for cellular phone and engine starter is formed is provided in a standing manner on the base member 11 and a second antenna board 44 in which a patch antenna 45 which can receive a radio wave for GPS is mounted is laid on the base member 11.

Moreover, as shown in FIG. 4, the base member 11 is fixed to the protection member 50a so as to face outside from an opening of an approximately square shape which is formed in the protection member 50a. Here, the protection member 50a of the bottom surface of the antenna main body 50 and the base member 11 may be formed of a same member.

At the center of the base member 11, a cylindrical nut portion 111 in which a female screw 111a which screws with the bolt 13 is formed is formed.

At the center of each of the four sides of the base member 11, a guiding portion 112 of a rectangle shape which guides the fixation member 12 to a predetermined position is formed. The guiding portions 112 are formed so as to surround the nut portion 111.

Further, at one corner of the base member 11, a positioning unit 113 for deciding the position of the base member 11 with respect to the mounting surface 60 is formed.

The protection member 50a is made of an elastic body, and ribs 50b and 50c are formed on the protection member 50a. The rib 50b is planarly formed by layering a plurality of frame shapes through which the base member 11 is to be exposed. The rib 50c is formed at the periphery of the bottom surface of the antenna main body 50. The ribs 50b and 50c have a water-proof and dust-proof effect to prevent water, dust and the like from entering inside of the antenna main body 50, the fixation mechanism 30 and the mounting surface 60 after the antenna apparatus 1 is attached to the mounting surface 60.

On the base member 11, a snap connector 14 for connecting the wiring is to be arranged in each of the four regions which are marked off by straight lines each of which extending to each of the four guiding portions 112 from the nut portion 111. Here, a case where three snap connectors 14 are arranged is shown. The snap connectors 14 are exposed at the back side of the second antenna board 44 via the connector attachment openings 114 which are formed in the base member 11. Further, the bottom of the connector main body 142 of each of the snap connectors 14 is fixed to the second antenna board 44 by soldering, for example.

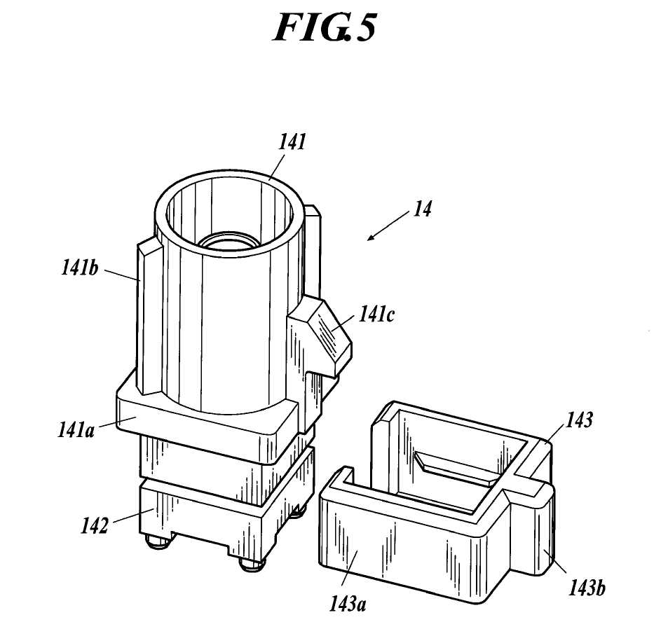

FIG. 5 is a diagram showing an example of the snap connector.

The snap connector 14 shown in FIG. 5 is structured by the connector main body 142 being fit into the connector cover 141. The connector cover 141 is formed by a cylindrical body 141b being provided on a rectangular base body 141a in a standing manner, wherein the external shape of the cylindrical body 141b is smaller than the base body 141a. A locking piece (hook) 141c to snap and engage with a connector (not shown in the diagram) on the wiring side is formed on the outer circumference surface of the cylindrical body 141b. Further, the external shape of the bottom part of the connector main body 142 (part which is exposed from the connector cover 141) is smaller than the external shape of the base body 141a of the connector cover 141.

At the bottom part of the connector main body 142, an elastically deformable spacer 143 which is made of resin is attached. The external shape of the spacer 143 approximately matches the shape which is the projection of the connector cover 141 in its shaft direction. That is, the squared U-shape portion 143a of the spacer 143 corresponds with the base body 141a of the connector cover 141, and the projecting portion 143b corresponds with the locking piece 141c. Further, the inner shape of the spacer 143 matches the external shape of the bottom part of the connector main body 142.

The bottom part of the connector main body 142 is fitted into the squared U-shape portion 143a of the spacer 143 while stretch opening the sides of the squared U-shape portion 143a which is opened by elastically deforming the spacer 143. Thereby, the spacer 143 is attached to the connector main body 52.

In the embodiment, the spacer 143 is structured as a member different from the connector cover 141 and the connector main body 142. Therefore, a general snap connector can be used.

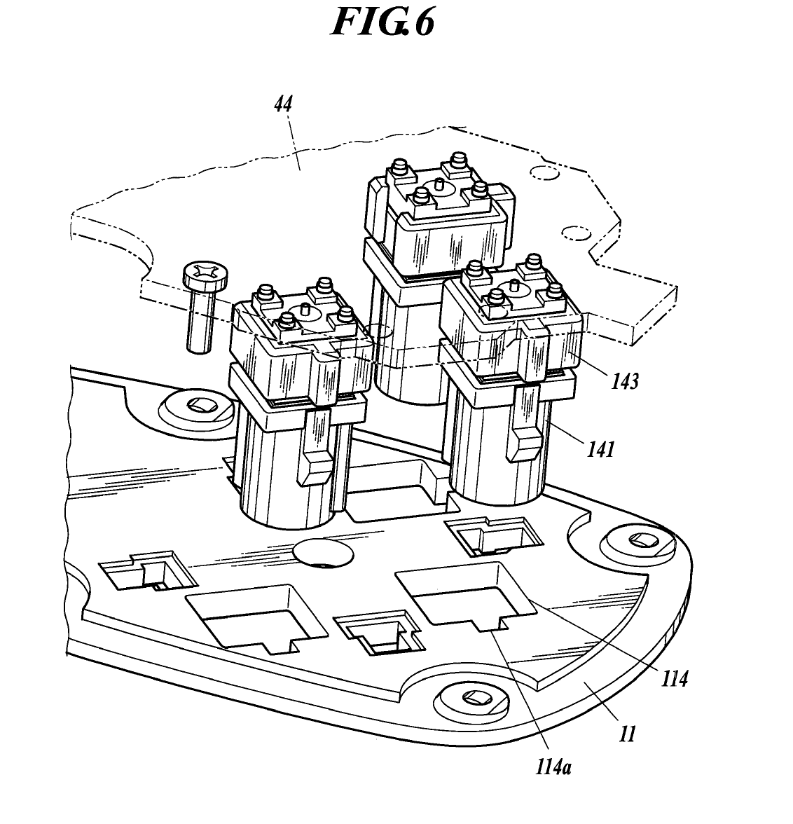

FIG. 6 is a diagram showing a method for fixing the second antenna board 44 on which the snap connectors 14 are mounted to the base member.

As shown in FIG. 6, openings 114 each of which having a shape in which the snap connector 14 can be inserted therein, that is, about the same size or slightly larger than the base body 141a of the connector cover 141, are formed in the base member 11. Further, a convex notch portion 114a is formed at each of the openings 114 of the base member 11 so that the locking piece 141c of the connector cover 141 can be inserted.

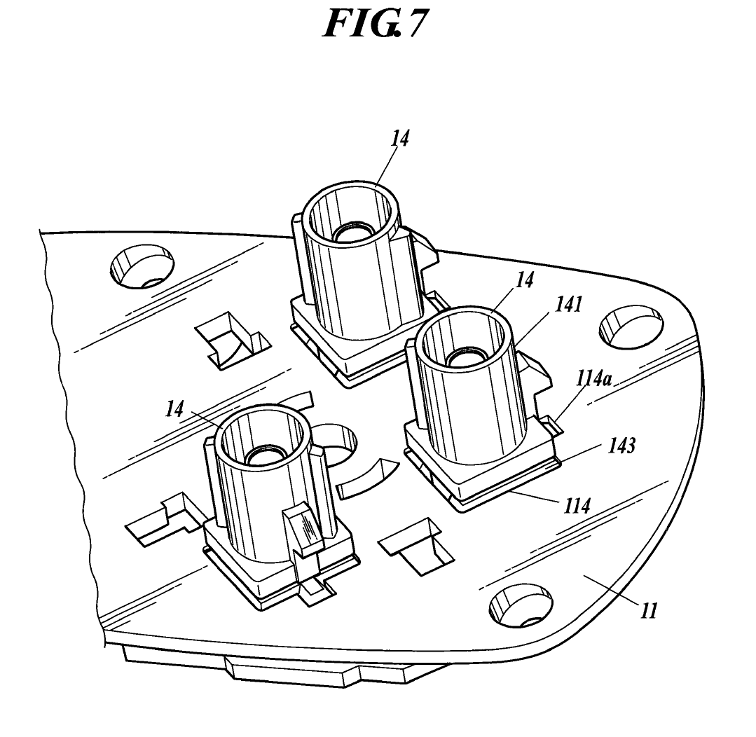

By inserting the snap connectors 14 into the openings 114 of the base member 11 in a state where the snap connectors 14 are mounted on the second antenna board 44 and by screwing the second antenna board 44 to the base member 11, the second antenna board 44 is fixed to the base member 11 (see FIG. 7).

At this time, the spacers 143 of the snap connectors 14 are fit to the openings 114 of the base member 11 forming a state where there is no space therebetween. That is, each of the snap connectors 14 contacts inside of the opening 114 of the base member 11 via the spacer 143.

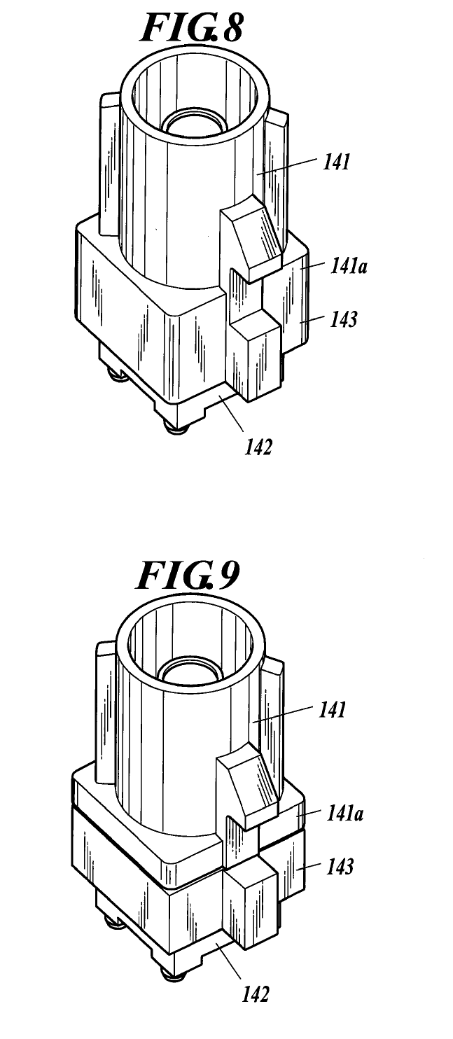

In the antenna main body 50 of the embodiment, the spacer 143 is structured as a member different from the connector cover 141 and the connector main body 142 in the snap connector 14. However, as shown in FIG. 8, the spacer 143 may be formed integrally with the base body 141a of the connector cover 141. Further, as shown in FIG. 9, the spacer 143 may be formed integrally in continuation with the connector main body 142, and the base body 141a of the connector cover 141 may contact the spacer 143.

According to the snap connectors shown in FIGS. 8 and 9, the process of attaching the spacer 143 which is a different member can be omitted as in the snap connector 14. Therefore, the productivity can be improved.

Moreover, as shown in FIG. 4, at the nut portion 111 of the base member 11, fitting holes 111b which fit with the after-mentioned rotation inhibiting unit 123 are formed facing each other having the male screw 111a therebetween.

In each of the two guiding portions 112 and 112 of the base member 11 which face each other, a restraining piece 112a which prohibits the fixation member 12 from rotating with the screwing of the bolt 13 is formed at the end of screwing rotation direction of the bolt 13 on the upper surface.

The external shape A of the protruded part of the base member 11 which is defined by the positioning unit 113 and the four guiding portions 112 is approximately the same as the shape of the fixation opening 60a of the mounting surface 60. Therefore, when fixing the antenna apparatus 1 to the mounting surface 60, the base member 11 fits into the fixation opening 60a.

Moreover, at each of the four guiding portions 112, a hook 112b for holding the mounting surface 60 with the base member 11 is formed.

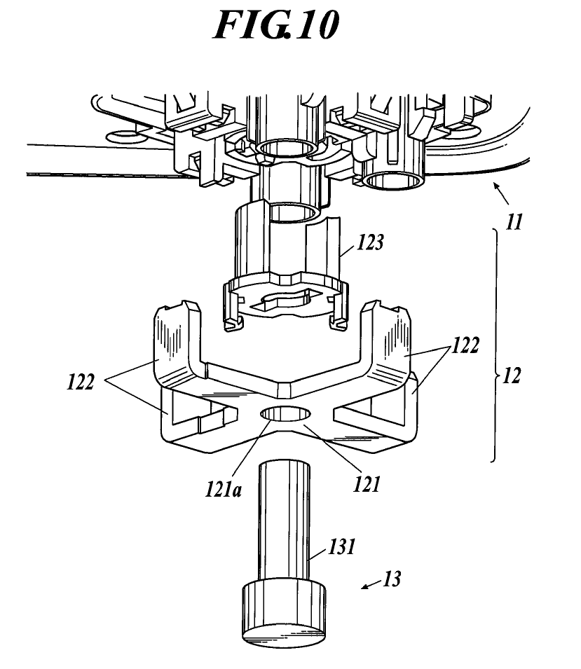

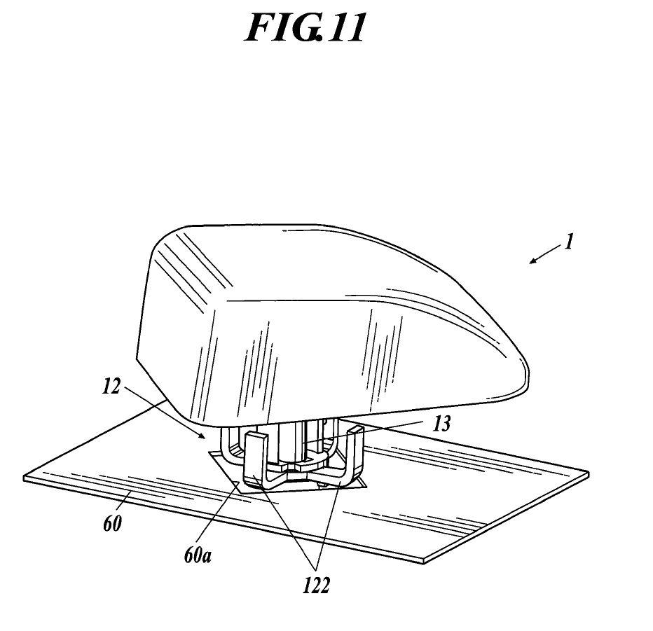

FIG. 10 is an exploded diagram of the fixation mechanism 10.

As shown in FIG. 10, the fixation member 12 includes a rotation shaft portion 121 in which an insertion hole 121a to insert the bolt 13 is formed, legs 122 which extend radially from the rotation shaft portion 121 in four directions, each of which forming 90 degrees from each other, and which are bent in L-shape toward the base member 11 and rotation inhibiting portions 123 which restrain the fixation member 12 from rotating with the screwing of the bolt 13.

The rotation shaft portion 121 and the legs 122 are fixation brackets which are structured with a metallic material, for example. The lengths from the rotation shaft portion 212 to the bent part of each of the legs 122 is set to a length that enables the fixation member 12 be inserted into the fixation opening 60a of the mounting surface 60 and enables the tips of the legs 122 position at periphery of the fixation opening 60a when the fixation member 12 is rotated in a state where the fixation member 12 is inserted in the fixation opening 60a.

For example, the length to the bent portion of each of the legs 122 from the rotation shaft portion 121 corresponds to the length to the apexes of the corners from the gravity center of the fixation opening 60a of the mounting surface 60. That is, the rotation shaft portion 121 corresponds to the gravity center of the fixation opening 60a and the two straight lines formed by the four legs 122 correspond to the diagonal lines of the fixation opening 60a.

Thereby, the fixation member 12 can be inserted from the fixation opening 60a, and the tips of the legs 122 of the fixation member 12 always position at the periphery of the fixation opening 60a when the fixation member 12 is rotated, the bolt 13 being the shaft center.

Moreover, the fixation opening 60a is formed in an approximately square shape and the legs 122 of the fixation member 12 are formed in the same length. Therefore, the mounting surface 60 can be supported uniformly and a stable fixation state can be realized. Further, the designing of the base member 11 and the fixation member 12 can be simple.

The rotation inhibiting unit 123 is formed of a resin material, for example, and is formed to be longer than the length of the legs 122 (the length from the bent part to the tip). The rotation inhibiting unit 123 is structured as a member different from the fixing bracket which is defined by the rotation shaft portion 121 and the legs 122 and is engaged to the crotch portion of the legs 122.

Here, the fixation bracket and the rotation inhibiting unit 123 may be molded integrally by insert molding or the fixation bracket and the rotation inhibiting unit 123 may be formed as one member with same material by metal mold pressing. Further, the structure may be such that the rotation inhibiting unit 123 is not provided to the fixation member 12.

The male screw 131 which screws with the female screw 111a formed at the nut portion 111 of the base member 11 is formed at the bolt 13. The fixation mechanism 10 is structured by screwing the bolt 13 to the nut portion 111 of the base member 11 in a state where the bolt 13 is inserted into the fixation member 12.

At the beginning of the screwing (temporary joint state), the tips of the rotation inhibiting unit 123 are respectively inserted in the engaging holes 111b of the nut portion 111. Therefore, the position of the fixation member 12 is decided in a state where the legs 122 correspond to the outside surface of the guiding portions 112 of the base member 11. That is, in the temporary joint state, the fixation member 12 cannot rotate with respect to the base member 11. The antenna apparatus 1 is delivered to the manufacturer in this temporary joint state.

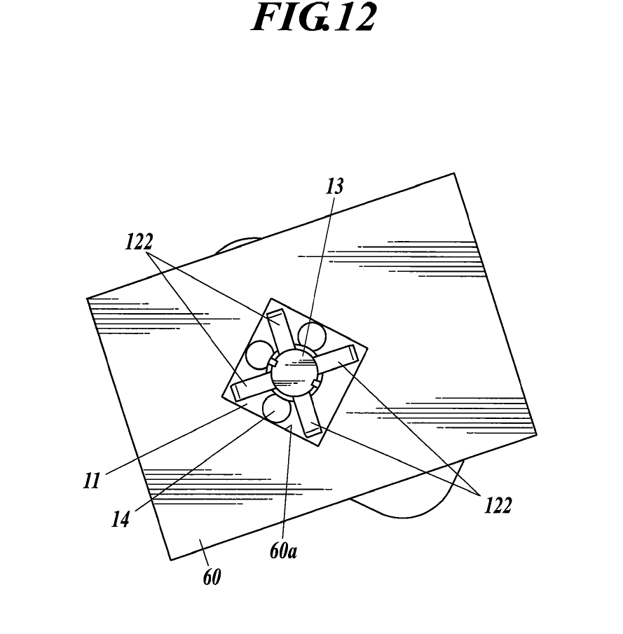

FIGS. 11 to 17 are diagrams showing the attachment process when the antenna apparatus 1 is to be fixed to the mounting surface 60.

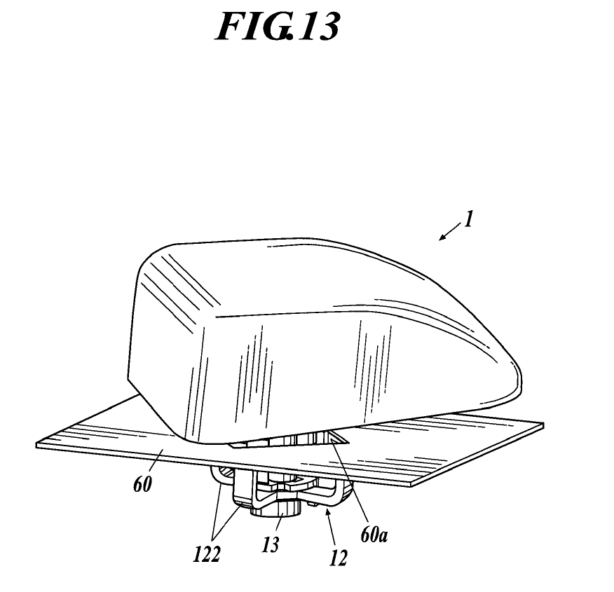

First, in the state where the fixation mechanism 10 is temporary joined to the antenna main body 50, the antenna apparatus 1 is arranged on the mounting surface 60 so that the legs 122 position on the diagonal lines of the fixation opening 60a (see FIGS. 11 and 12). Then, the fixation member 12 and the bolt 13 are inserted into the fixation opening 60a (see FIG. 13). Because the two straight lines formed by the four legs 122 of the fixation member 12 correspond to the diagonal lines of the fixation opening 60a, the fixation member 12 and the bolt 13 can be inserted into the fixation opening 60a only when the antenna apparatus 1 is arranged as shown in FIGS. 11 and 12.

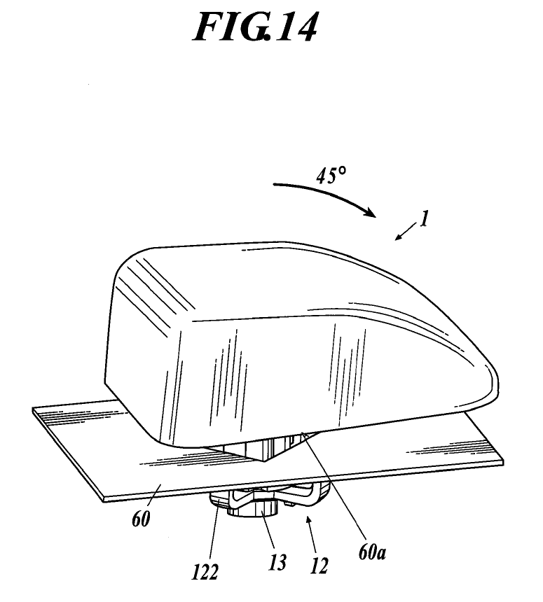

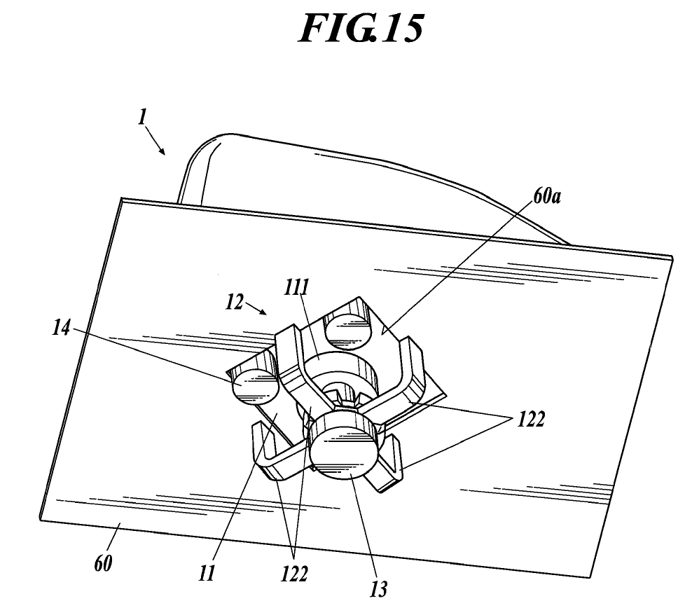

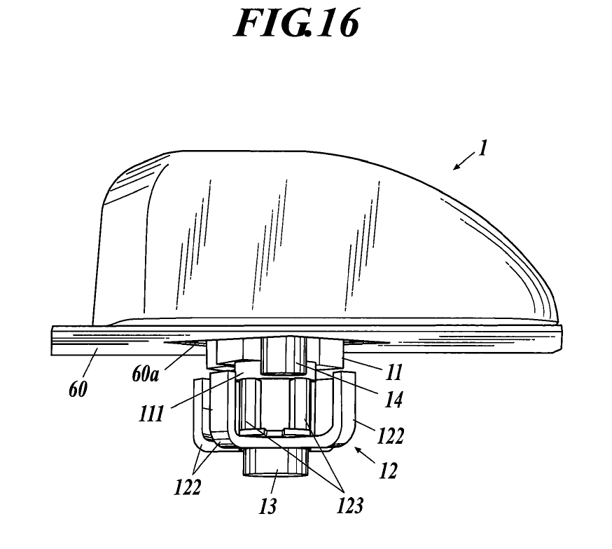

Next, the antenna apparatus 1 is rotated with respect to the mounting surface 60 for a predetermined angle (see FIGS. 14 and 15, here, the angle is 45 degrees in clockwise direction), and the base member 11 is inserted and fit into the fixation opening 60a (see FIG. 16). At this time, as shown in FIG. 15, each of the tips of the legs 122 is to be positioned at approximately center of each of the peripheral sides of the fixation opening 60a. Further, as shown in FIG. 16, the direction of the antenna apparatus 1 is fixed by the guiding portions 112 and the positioning unit 113 of the base member 11. Here, the mounting surface 60 is held by the hooks 112b and the base member 11.

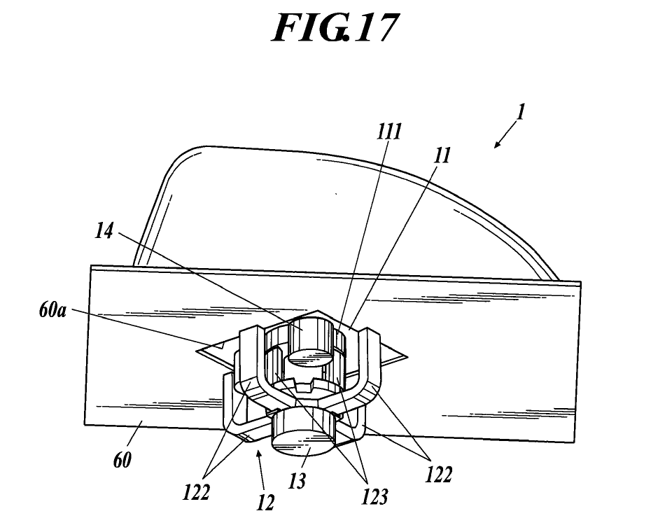

Next, when the bolt 13 is screwed into the nut portion 111 of the base member 11, the fixation member 12 moves to the base member 11 side (the mounting surface 60 side) with the screwing of the bolt 13 and the mounting surface 60 is to be held by the tips of the legs 122 and the base member 11 (the bottom surface 50a of the antenna apparatus 1) (see FIG. 17). Moreover, by screwing the bolt 13 into the nut portion 111 of the base member 11, the antenna apparatus 1 is firmly fixed to the mounting surface 60.

At this time, as for the fixation member 12, the inner surfaces of the legs 122 move along the outside surfaces of the guiding portions 112 of the base member 11.

Moreover, because the fixation member 12 cannot rotate with respect to the base member 11 due to the rotation inhibiting unit 123, the positions of the legs 122 will not move with the screwing of the bolt 13. At the time of screwing of the bolt 13, rotation force which cannot be absorbed only by the rotation inhibiting unit 123 (there is a possibility that the rotation inhibiting unit 123 will break) is to be applied to the fixation member 12. However, because the legs 122 of the fixation member 12 are locked by the restraining pieces 112a which are formed at the guiding portions 112 of the base member 11, the positions of the legs 122 do not move.

In such way, the antenna apparatus 1 of the first embodiment can be inserted in the fixation opening 60a with the base member 11 on which the nut portion 111 is formed, and further, the antenna apparatus 1 of the first embodiment includes the fixation member 12 having a shape (legs 122) that can contact the periphery of the fixation opening 60a in the attached state and the bolt 13 which is screwed to the nut portion in a state where the bolt 13 is inserted in the fixation member 12.

Further, the fixation member 12 and the bolt 13 are inserted in the fixation opening 60a and the fixation member 12 (along with the antenna main body 50) is rotated for a predetermined angle, the bolt 13 being the shaft center. Thereafter, the bolt 13 is screwed into the nut portion 111, and the mounting surface 60 is held by the base member 11 and the fixation member 12 (tips of the legs 122). Thereby, the antenna apparatus 1 is fixed to the mounting surface 60.

In such way, there is no need to separate the fixation member 12 and the bolt 13 when attaching the antenna apparatus 1 which is delivered in the temporary joint state to the mounting surface 60. Therefore, the efficiency of the attachment operation can be maintained and the antenna apparatus 1 can be firmly fixed to the mounting surface 60 via the fixation opening 60a having a large aperture.

Further, because the antenna apparatus 1 can be applied to the fixation opening 60a having a large aperture, the wiring using direct connector can be connected.

Furthermore, the fixation member 12 includes the rotation inhibiting unit 123 which is formed facing the base member 11, and the base member 11 includes the engaging holes 111b in which the rotation inhibiting unit 123 is to be engaged when the bolt 13 is screwed into the nut portion 111.

Thereby, the fixation member 12 can be restrained from rotating with the screwing of the bolt 13. Therefore, the attachment operation of the antenna apparatus 1 becomes easy and the mounting surface 60 can be held surely by the tips of the legs 122 of the fixation member 12 and the base member 11.

Moreover, in the antenna apparatus 1 of the embodiment, when the circuit board (the second antenna board 44) on which the snap connectors 14 as connectors of snap engaging type are mounted is fixed to the base member 11, the snap connectors 14 are to be inserted in the openings 114 formed in the base member 11. Further, each of the snap connectors 14 includes the spacer 143 having the same external shape as the openings 114 of the base member 11, and each of the snap connectors 14 contacts inside of the opening 114 via the spacer 143.

In such way, when the second antenna board 44 on which the snap connectors 14 are mounted is fixed to the base member 11, a space will not be formed between the snap connectors 14 and the openings 114 of the base member 11. Therefore, dusts can be prevented from entering in the antenna main body 50 effectively. Further, the second antenna board 44 can be fixed to the base member 11 after the snap connectors 14 are mounted on the second antenna board 44. Therefore, the attachment operation will not be troublesome as in the case where snap connectors of separate type are used.

### Second Embodiment

In FIG. 1, the second symbol among the symbols attached to each part corresponds to the second embodiment. The antenna apparatus 2 of the second embodiment has a structure similar to that of the antenna apparatus 1 of the first embodiment except that the structure of the fixation mechanism 20 differs from that of the fixation mechanism 10. That is, in the first embodiment, the position of the antenna apparatus 1 is decided so as to face a predetermined direction by rotating the antenna apparatus 1 after inserting the fixation mechanism 10 into the fixation opening 60a. On the other hand, in the second embodiment, the position of the antenna apparatus 2 is decided so as to face a predetermined direction in a state where the fixation mechanism 20 is inserted in the fixation opening 60a. Here, detail descriptions for the structures similar to that of the first embodiment will be omitted.

As shown in FIG. 1, the fixation mechanism 20 of the antenna apparatus 2 of the second embodiment includes a base member 21 which is provided so as to protrude from the protection member 50a which is provided at the bottom surface of the antenna main body 50, a fixation member 22 which holds the mounting surface with the protection member 50a of the antenna main body 50 and a bolt 23 which is screwed into the base member 21 in a state where the bolt 23 is inserted in the fixation member 22.

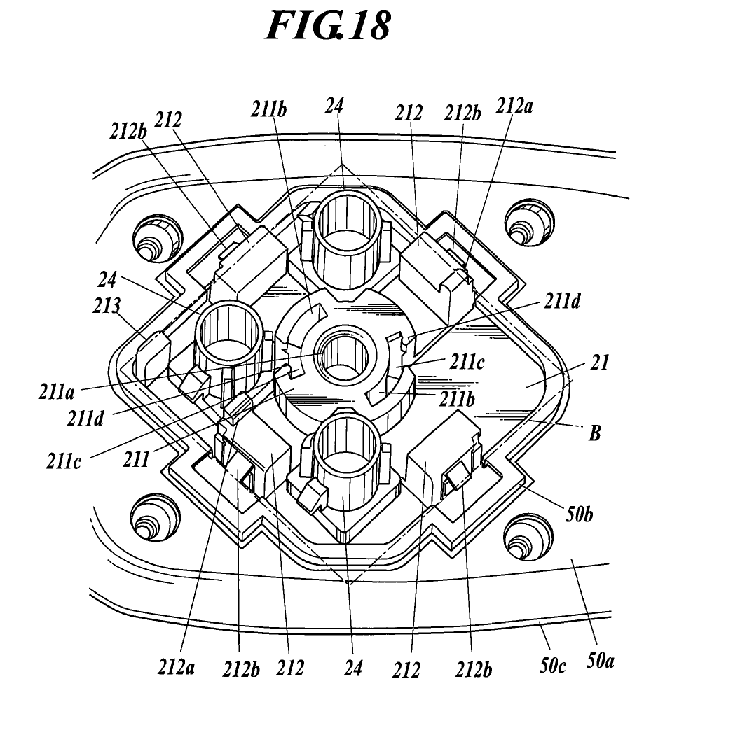

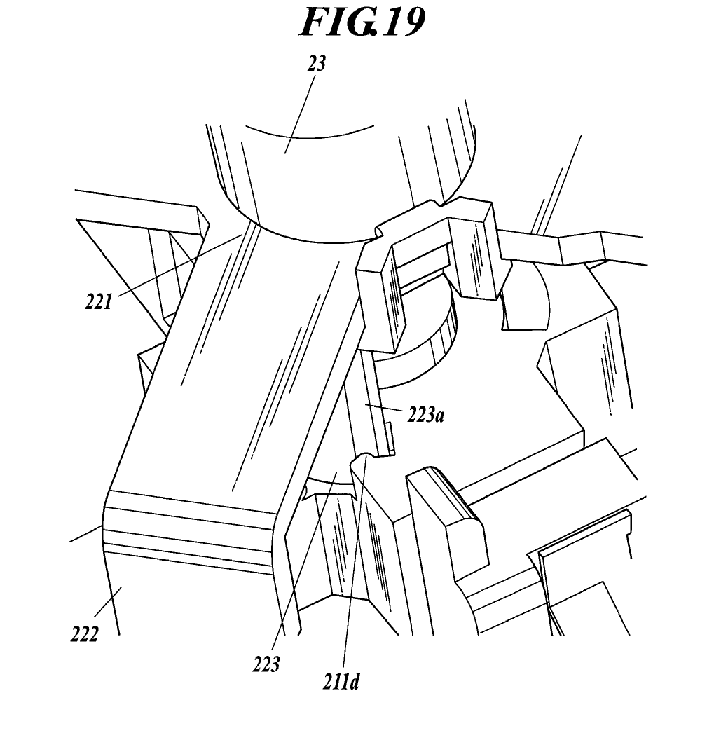

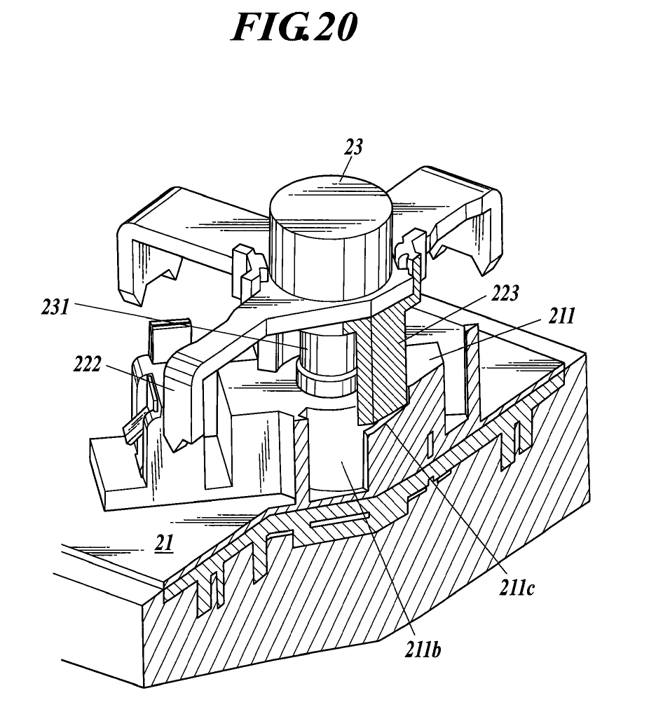

FIG. 18 is a diagram showing the structure of the base member 21 and FIGS. 19 and 20 are diagrams showing the structure of the fixation mechanism 20. In FIG. 20, a partial cross-section view of the antenna apparatus 2 which is cut along a curved line which passes through the stepped portion.

As shown in FIG. 18, at the center of the base member 21, a cylindrical nut portion 211 in which a female screw 211a which screws with the bolt 23 is formed is provided. At the nut portion 211, engaging holes 221b which engage with the after-mentioned rotation inhibiting unit 223 are formed at positions facing each other by having the female screw 211a therebetween.

Further, the stepped portion 211c is provided in each engaging hole 211b in continuation with the engaging hole 211b, the stepped portion 211c being shallower than the engaging hole 211b. At a side wall of each stepped portion 211c, a convex portion 211d which engages with each of the concave portions 223a of the after-mentioned rotation inhibiting unit 223 is formed.

At the center of each of the four sides of the base member 21, a rectangular guiding portion 212 which guides the fixation member 22 to a predetermined position is provided, the guiding portions 212 surrounding the nut portion 211. With respect to the two guiding portions 212 which face each other, restraining pieces 212a, 212a for restraining the fixation member 22 from rotating with the screwing of the bolt 23 are respectively formed at ends on the upper surfaces of the guiding portions 212 in the screwing rotation direction of the bolt 23.

At one corner of the base member 21, a positioning unit 213 for deciding the position of the base member 21 with respect to the mounting surface 60 is formed. The external shape B of the protruded part of the base member 21 which is defined by the positioning unit 213 and the four guiding portions 212 is approximately the same shape as the fixation opening 60a of the mounting surface 60. Therefore, when fixing the antenna apparatus 2 to the mounting surface 60, the base member 21 fits into the fixation opening 60a.

Moreover, at each of the four guiding portions 212, a hook 212b for holding the mounting surface 60 with the base member 21 is formed.

In the base member 21, a snap connector 24 for connecting a wiring is arranged in each of the four regions which are marked off by straight lines each of which extending to each of the four guiding portions 212 from the nut portion 211. Here, a case where three snap connectors 24 are arranged is shown.

As shown in FIGS. 19 and 20, the fixation member 22 includes a rotation shaft portion 221 in which an insertion hole 221a through which the bolt 23 is inserted is formed, legs 222 which extend radially from the rotation shaft portion 221 in four directions, each of which forming 90 degrees from each other, and which are bent in L-shape toward the base member 21 and the rotation inhibiting unit 223 for restraining the fixation member 22 from rotating with the screwing of the bolt 23.

The rotation inhibiting unit 223 is formed of a resin material, for example, and is longer than the length of the legs 122 (the length to the tip from the bent part). Further, at the outside peripheral surface of the rotation inhibiting unit 223, concave portions 223 which engage with the convex portions 211d formed at the nut portion 211 of the base member 21 are formed.

The rotation inhibiting unit 223 is structured as a member different from the fixation bracket which is defined by the rotation shaft portion 221 and the legs 222, and the rotation inhibiting unit 223 is engaged to the crotch portion of the legs 222. Here, the rotation inhibiting unit 223 may be formed integrally with the fixation bracket by insert molding.

At the bolt 23, a male screw 231 which screws with the female screw 211 which is formed at the nut portion 211 of the base member 21 is formed. The fixation mechanism 20 is structured by screwing the bolt 23 into the nut portion 211 of the base member 21 in a state where the bolt 23 is inserted into the fixation member 22.

At the beginning of the screwing (temporary joint state), the tips of the rotation inhibiting unit 223 are positioned at the stepped portions of the nut portion 211 and the tips of the legs 222 are positioned at positions shifted for a predetermined angle (for example, 45 degrees) from the guiding portions 112 of the base member 21. At this time, by each of the convex portions 211d formed at the nut portion 211 and each of the concave portions 223a formed at the rotation inhibiting unit 223 engaging with each other, the fixation member 22 is temporarily fixed to the base member 21 (locked state). That is, in this state, the fixation member 22 does not rotate easily, however, the locked state of the fixation member 22 and the base member 21 is to be easily released by the rotation force associated with the screwing of the bolt 23. The antenna apparatus 2 is delivered to the manufacturer in this temporary joint state.

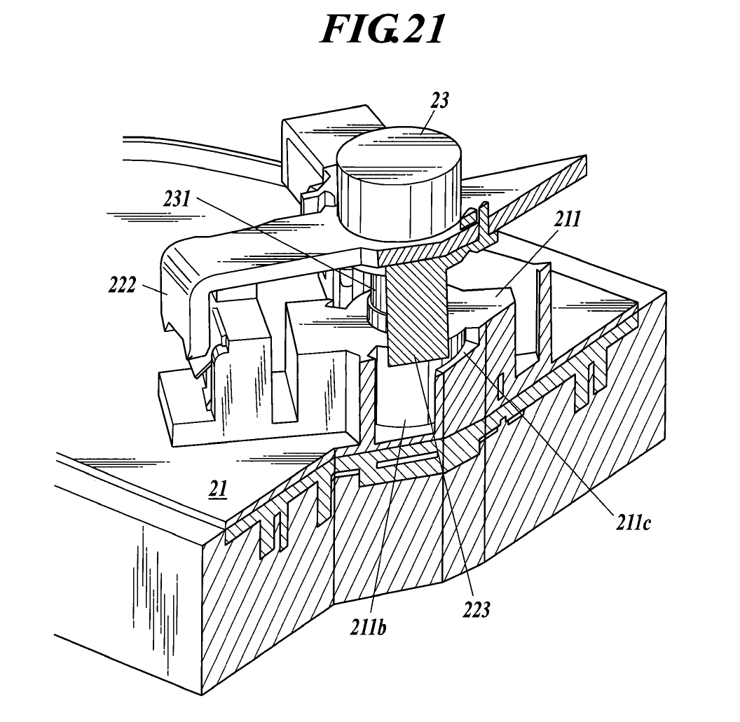

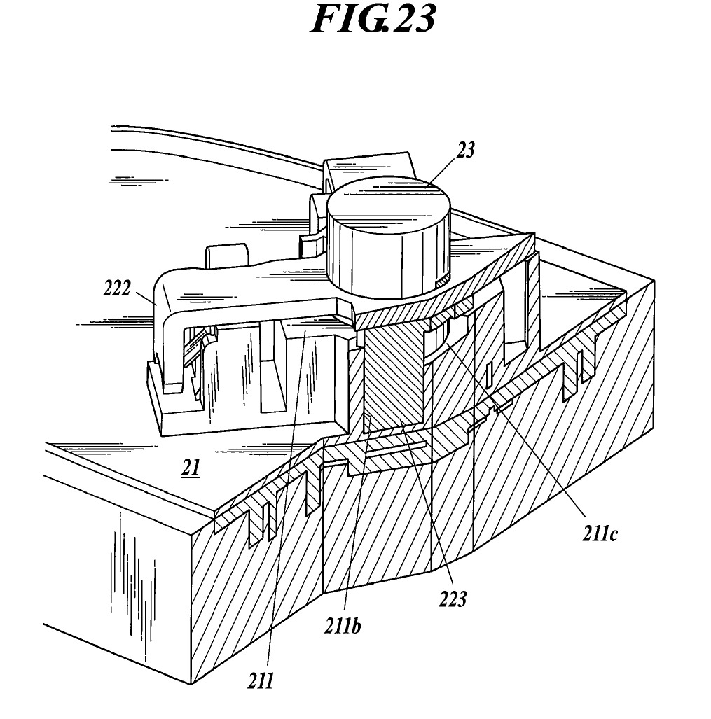

FIGS. 21 to 23 are diagrams showing the attachment process which is carried out when fixing the antenna apparatus 2 to the mounting surface 60. Here, the mounting surface 60 is omitted in FIGS. 21 to 23 and partial cross-sectional views of the antenna apparatus 2 when cut along a curved line which passes through the stepped portion are shown in FIGS. 21 and 23.

First, in a state where the fixation mechanism 20 is temporarily joined to the antenna main body 50, the antenna apparatus 2 is arranged on the mounting surface 60 so that the legs 222 position on the diagonal lines of the fixation opening 60a, and then, the fixation member 22 and the bolt 23 are inserted into the fixation opening 60a. At this time, the guiding portions 212 of the base member 21 are respectively positioned at center of the sides at the periphery of the fixation opening 60a. Therefore, the base member 21 is also inserted and fit into the fixation opening 60a. That is, in the above state, the position of the antenna apparatus 2 is decided to a predetermined direction.

Next, when the bolt 23 is screwed into the nut portion 211 of the base member 21, the locked state is released by the convex portions 211d formed at the nut portion 211 or the concave portions 223a formed at the rotation inhibiting unit 223 being elastically deformed by the rotation force of the bolt 23. Thereafter, the fixation member 22 is rotated along the stepped portion 211c and the tips of the rotation inhibiting unit 223 are inserted in the engaging holes 221b, respectively (see FIG. 21). At this time, the legs 222 of the fixation member 22 correspond to the external surface of the guiding portions 212 of the base member 21, respectively, and in this state, the position of the fixation member 22 is decided with respect to the base member 21.

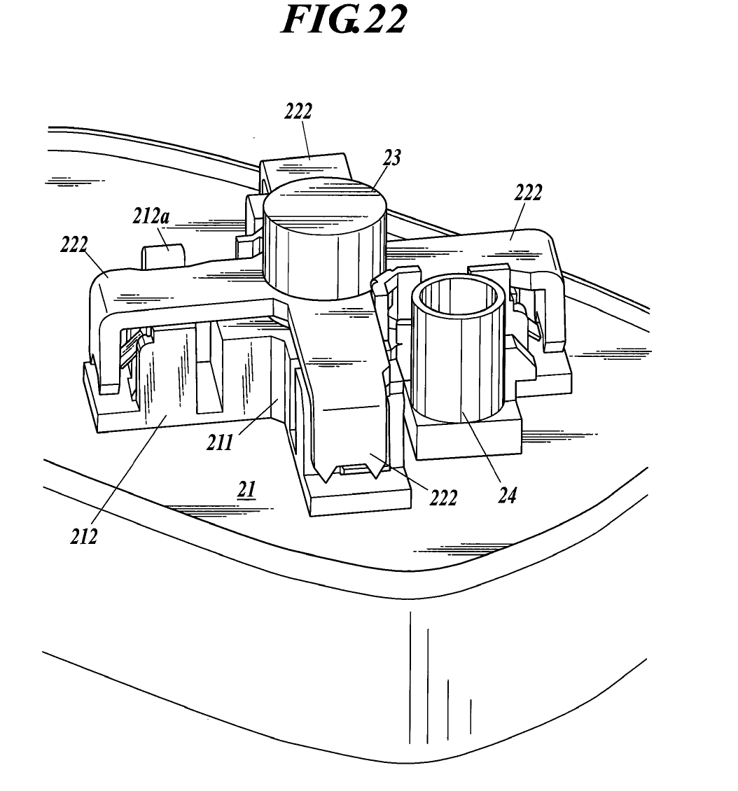

Next, when the bolt 23 is screwed into the nut portion 211 of the base member 21, the fixation member 22 moves to the base member 21 side (the mounting surface 60 side) with the screwing, and the mounting surface 60 is held by the tips of the legs 222 and the base member 21 (see FIG. 22). Further, by screwing the bolt 23 into the nut portion 221 of the base member 21, the antenna apparatus 2 is firmly fixed to the mounting surface 60.

As described above, the antenna apparatus 2 of the second embodiment includes the base member 21 in which the nut portion 211 is formed, the fixation member 22 which can be inserted into the fixation opening 60a and which has a shape (legs 222) that can contact the peripheral portion of the fixation opening 60a in the attached state and the bolt 23 which is screwed into the nut portion 211 in a state where the bolt 23 is inserted into the fixation member 22.

Further, the fixation member 22 and the bolt 23 are inserted into the fixation opening 60a and the fixation member 22 is rotated for a predetermined angle, the bolt 13 being the shaft center (independently from the antenna main body 50). Thereafter, the bolt 23 is screwed into the nut portion 211 to hold the mounting surface 60 by the base member 21 and the fixation member 22 (tips of the legs 222) and the antenna apparatus 2 is fixed to the mounting surface 60.

In such way, when the antenna apparatus 2 which is delivered in the temporary joint state is to be attached to the mounting surface 60, there is no need to separate the fixation member 22 and the bolt 23. Therefore, the efficiency of the attachment operation can be maintained and the antenna apparatus 2 can be firmly fixed to the mounting surface 60 via the fixation opening 60a having a large aperture.

Moreover, because the antenna apparatus 2 can be applied to the fixation opening 60a having a large aperture, the wiring using direct connector can be connected.

Further, the fixation member 22 includes the rotation inhibiting unit 223 which is formed facing the base member 21, and the base member 21 includes the engaging holes 211b in which the rotation inhibiting unit 223 is to be engaged when the bolt 23 is screwed into the nut portion 211.

Thereby, the fixation member 22 can be restrained from rotating with the screwing of the bolt 23. Therefore, the attachment operation of the antenna apparatus 2 can be easy and the mounting surface 60 can be surely held by the tips of the legs 222 of the fixation member 22 and the base member 21.

Moreover, the base member 21 includes the stepped portions each of which is provided at each of the engaging holes 211b in continuation with the engaging hole 211b. Further, the tips of the rotation inhibiting unit 223 are maintained in a state where contacting with the stepped portions 211c at the beginning (temporary joint state) of the screwing of the bolt 23 into the nut portion 211. Then, when the fixation member 22 is rotated for a predetermined angle, the rotation inhibiting unit 223 is to be engaged with the engaging holes 211b.

In such way, the positions of the legs 222 of the fixation member 22 in the temporary joint state can be different from the positions of the legs 222 when holding the mounting surface 60. Therefore, the direction of the antenna apparatus 2 can be adjusted easily so as to face a predetermined direction when inserting the legs 222 into the fixation opening 60a. That is, the position of the antenna apparatus 2 is decided to the predetermined direction at the beginning of the attachment, therefore, the efficiency of the attachment operation can be improved.

Moreover, the rotation inhibiting unit 223 includes the concave portions 223a at the periphery surface thereof and the stepped portion 211c includes the convex portions 211d which engage with the concave portions 223a, respectively. By the concave portions 223a and the convex portions 211d engaging with each other and being in the locked state, the rotation inhibiting unit 223 is maintained in the state where contacting the stepped portions 221c, and the locked state is to be released by the concave portions 223a or the convex portions 211d being elastically deformed in association with the rotation of the fixation member 22.

From the above, only by screwing the bolt 23, the locked state (temporary joint state) of the fixation member 22 and the base member 21 is released and the fixation member 22 is rotated to a predetermined position and is maintained at the position. Therefore, the efficiency of the attachment operation can be improved even more.

### Third Embodiment

In FIG. 1, the third symbol among the symbols attached to each part corresponds to the third embodiment. The antenna apparatus 3 of the third embodiment has a structure similar to that of the antenna apparatus 2 of the second embodiment except that the antenna apparatus 3 includes the antenna main body 50A and the fixation mechanism 30 instead of the antenna main body 50 and the fixation mechanism 20 of the second embodiment, respectively. Here, detail descriptions of the structures similar to that of the second embodiment will be omitted.

As shown in FIG. 1, a protection member 50d is provided at the bottom surface of the antenna main body 50A in the antenna apparatus 3 of the third embodiment. The fixation mechanism 30 includes a base member 31 which is formed so as to protrude from the protection member 50d provided on the bottom surface of the antenna main body 50A, a fixation member 32 which holds the mounting surface 60 with the protection member 50d of the antenna main body 50A and a bolt 33 which is to be screwed to the base member 31 in a state where the bolt 33 is inserted into the fixation member 32.

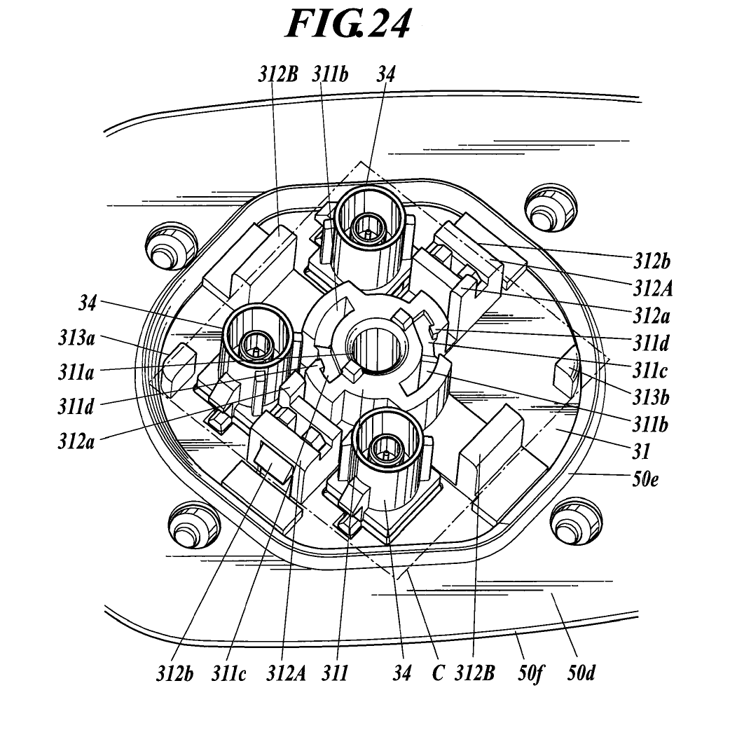

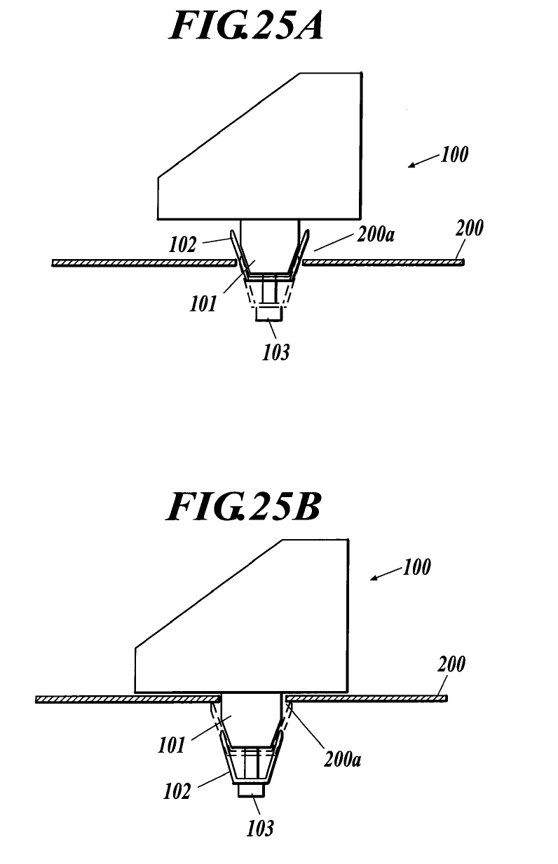

FIG. 24 is a diagram showing the structure of the base member 31 of the third embodiment.

As shown in FIG. 24, a cylindrical nut portion 311 is formed at the center of the base member 31 of the antenna apparatus 3 of the third embodiment. In the nut portion 311, a female screw 311a, engaging holes 311b, stepped portions 311c and convex portions 311d are formed. The female screw 311a, the engaging holes 311b, the stepped portions 311c and the convex portions 311d are similar to the female screw 211a, the engaging holes 211b, the stepped portions 211c and the convex portions 211d in the nut portion 211 of the second embodiment, respectively.

At the center of the four sides of the base member 31, rectangular guiding portions 312A and rectangular guiding portions 312B are respectively formed, the guiding portions 312A being a pair and positioned facing each other and the guiding portions 312B being a pair and positioned facing each other. The guiding portions 312A and the guiding portions 312B are surrounding the nut portion 311. With respect to the two guiding portions 312A and 312A, restraining pieces 312a and 312b for restraining the fixation member 32 from rotating with the screwing of the bolt 33 are respectively formed at the ends in the rotation direction of the bolt 33 on the upper surfaces thereof. Furthermore, in the guiding portions 312A and 312A, hooks 312b and 231b for holding the mounting surface 60 between the base member 31 are respectively formed.

The hooks 312b and 312b are formed of a resin material such as plastic or the like which can be elastically deformed, and the hooks 312b and 312b can be pushed inside of the guiding portions 312A and 312A. The guiding portions 312B and 312B do not include the hooks and excess thickness is cut comparing to the guiding portions 312A and 312A.

At one corner of the base member 31, positioning units 313a and 313b for deciding the position of the base member 31 with respect to the mounting surface 60 are formed. The positioning units 313a and 313b are formed at positions facing each other having the nut portion 311 therebetween. The positions of the positioning units 313a and 313b are positions which contact the inner periphery of the fixation opening 60a after the antenna apparatus 3 is attached to the mounting surface 60. The external shape C of the protruded part of the base member 31, which is defined by the positioning units 313a and 313b and the pair of guiding portions 312A and the pair of guiding portions 312B, is similar to the shape of the fixation opening 60a of the mounting surface 60. Therefore, when fixing the antenna apparatus 3 to the mounting surface 60, the base member 31 fits into the fixation opening 60a.

When attaching the antenna apparatus 3 to the mounting surface 60, the two hooks 312b and 312b which are protruded from the guiding portions 312A and 312A, respectively, are pushed into the guiding portions 312A and 312A while inserting and fitting the positioning units 313a and 313b and the guiding portions 312A and 312B in the fixation opening 60a of the mounting surface. Therefore, the inserting and fitting of the positioning units 313a and 313b and the guiding portions 312A and 312B into the fixation opening 60a of the mounting surface 60 can be carried out smoothly. After the positioning units 313a and 313b and the guiding portions 312A and 312B are inserted and fitted into the fixation opening 60a of the mounting surface 60, the two hooks 312b and 312b are protruded again to hold the mounting surface 60 with the base member 31.

In the base member 31, a snap connector 34 for connecting a wiring is arranged in each of the four regions which are marked off by straight lines each of which extending to each of the guiding portions 312A and the guiding portions 312B from the nut portion 311. Here, a case where three snap connectors 34 are arranged is shown.

Further, the protection member 50d is made of an elastic body. In the protection member 50d, tapered shape ribs 50e and 50f are formed. The rib 50e is planarly formed in an oval shape from which the base member 31 is exposed. The rib 50f is formed at the periphery of the bottom surface of the antenna main body 50a. The ribs 50e and 50f have a water-proof and dust-proof effect for preventing water, dust and the like from entering in the antenna main body 50, the fixation mechanism 30 and the mounting surface 60 from outside after the antenna apparatus 3 is attached to the mounting surface 60.

As described above, in the antenna apparatus 3 of the third embodiment, one pair of the guiding portions 312B and 312B do not have the hooks and they are shaped by cutting the excess thickness. Therefore, the structure of the antenna apparatus 3 can be simple and the antenna apparatus 3 can be light weighted. Further, one pair of guiding portions 312A and 312A has the resin made hooks 312b and 312b which can be pushed. Therefore, the attachment operation of the antenna apparatus 3 to the mounting surface 60 can be easier. In particular, by the hooks 312b and 312b being pushed in a state where the antenna apparatus 3 is attached to the mounting surface 60, the antenna apparatus 3 (the guiding portions 312A and 312B) can also be detached from the mounting surface 60 easily. Moreover, by the positioning units 313a and 313b, deciding of the position of the antenna apparatus 3 when attaching the antenna apparatus 3 to the mounting surface 60 can be carried out easily. Further, the rib 50e is planarly formed in an approximately circle shape. Therefore, the structure of the protection member 50d of the antenna apparatus 3 can be simple. Also, the stress applied to the rib 50e after the antenna apparatus 3 is attached to the mounting surface 60 becomes even, thus, the water-proof and dust-proof effect can be enhanced.

The invention achieved by the inventors is specifically described above based on the embodiments. However, the present invention is not limited to the above described embodiments, and can be modified within the scope of the invention.

In the embodiments, shape of the fixation opening which is formed in the mounting surface is an approximately square shape. However, the present invention can be applied in any polygonal shape such as a triangle, a rectangle and the like other than a circle, for example.

Moreover, in the second embodiment, as long as the locked state is to be released by elastic deformation, the structure for realizing the temporary joint of the base member 21 and the fixation member 22 (the convex portions 211d and the concave portions 223a) is not particularly limited in their shape, size, number, arrangement positions and the like.

Further, application of the snap connectors of the above embodiments and FIGS. 8 and 9 is not limited to the antenna apparatus described in the above described embodiments, and the snap connectors can be generally applied to the apparatuses having the attachment structure of a connector in which the snap connector is to be in a state where being inserted in the opening formed in the base member when fixing the circuit board on which the snap connector is mounted to the base member.

The embodiments described above are examples in all aspects and do not limit the present invention in any way. The scope of the invention is intended to be limited solely by the scope of the claims that follow and not by the above descriptions. Further, the scope of the invention includes all the modifications within the scope of the claims and equivalents thereof.

The present U.S. patent application claims a priority under the Paris Convention of Japanese Paten Application No. 2010-061731 filed on Mar. 18, 2010, Japanese Patent Application No. 2010-061739 filed on Mar. 18, 2010 and Japanese Patent Application No. 2011-047211 filed on Mar. 4, 2011, which shall be a basis of correction of an incorrect translation.

What is claimed is:

1. A fixation structure of an antenna apparatus in which the antenna apparatus is fixed to a fixation opening provided in a mounting surface, comprising:
a base member in which a nut portion is formed;
a fixation member which is inserted in the fixation opening and has a shape that can contact with a periphery of the fixation opening when the antenna apparatus is attached to the mounting surface; and
a bolt which is screwed into the nut portion in a state where the bolt is inserted into the fixation member,
wherein
the bolt is screwed into the nut portion to hold and fix the mounting surface by the base member and the fixation member after the fixation member and the bolt are inserted into the fixation opening and the fixation member is rotated for a predetermined angle, the bolt being a shaft center,
the fixation member comprises a rotation inhibiting unit which is formed facing the base member, and
the base member comprises an engaging hole by which the rotation inhibiting unit is engaged when the bolt is screwed into the nut portion.

2. The fixation structure of the antenna apparatus as claimed in claim 1, wherein
the base member comprises a stepped portion which is provided in the engaging hole in continuation with the engaging hole,
the rotation inhibiting unit is maintained to be in a state contacting with the stepped portion at beginning of screwing of the bolt into the nut portion and the rotation inhibiting unit is engaged with the engaging hole when the fixation member is rotated for the predetermined angle.

3. The fixation structure of the antenna apparatus as claimed in claim 2, wherein
the rotation inhibiting unit comprises a concave portion at a periphery surface of the rotation inhibiting unit,
the stepped portion comprises a convex portion which engages with the concave portion, and
the rotation inhibiting unit is maintained to be in the state contacting with the stepped portion by the concave portion and the convex portion engaging with each other to be in a locked state, and the locked state is released by the concave portion or the convex portion being elastically deformed in association with a rotation of the fixation member.

4. The fixation structure of the antenna apparatus as claimed in claim 1, wherein
the fixation opening has a polygonal shape,
the fixation member comprises a rotation shaft portion in which an insertion hole for inserting the bolt is formed and a plurality of legs which extend radially from the rotation shaft portion and are bent in a L-shape toward the base member, and
lengths from a center of the rotation shaft portion to bent parts of the plurality of legs correspond to lengths from a gravity center of the fixation opening to corner apexes of the fixation opening.

5. The fixation structure of the antenna apparatus as claimed in claim 4, wherein the fixation opening has a regular polygon shape.
